(19) United States
(12) Patent Application Publication
(10) Pub. No.: US 2005/0066817 A1
(43) Pub. Date: Mar. 31, 2005

(54) Mechanically stable porous activated carbon molded body, a process for the production thereof and a filter system including same

(76) Inventor: Thomas Wolff, Munchberg (DE)

Correspondence Address: FULBRIGHT & JAWORSKI, LLP, 1301 MCKINNEY, SUITE 5100, HOUSTON, TX, 77010-3095, US

(21) Appl. No.: 10/918,245

(22) Filed: Aug. 13, 2004

(30) Foreign Application Priority Data
Aug. 16, 2003 (DE) 10337584.8
Oct. 4, 2003 (DE) 10346061.6

(51) Int. Cl. C01B 31/08; B01D 53/02

(52) U.S. Cl. 96/108; 264/29.1; 210/263

(57) ABSTRACT

A mechanically stable porous activated carbon molded body has a lattice structure which includes carbonised resin and pyrolysed silicone resin and in which activated carbon particles are embedded. A process for the production of such a body includes mixing activated carbon particles, carbonisable resin, pyrolysable silicone resin and optionally further additives with the addition of a liquid phase to provide a workable mass, molding the mass to give a molded body, drying the resulting molded body and pyrolysing the dried molded body. The invention further concerns a filter system including such a body.

### CROSS-REFERENCES TO RELATED APPLICATIONS

This application claims the priorities of German patent applications Serial Nos 103 37 584.8 filed Aug. 16, 2003 and 103 46 061.6 flied Oct. 4, 2003.

### FIELD OF THE INVENTION

The invention concerns a mechanically stable porous activated carbon molded or shaped body, referred to hereinafter as a molded body.

The invention also concerns a process for the production of the activated carbon molded body, as well as a filter system including the activated carbon molded body.

### BACKGROUND OF THE INVENTION

DE 101 04 882 A1 discloses an activated carbon molded body having a very high proportion of activated carbon and a correspondingly high adsorption capability. The activated carbon is bound in that case by way of pyrolised phenolic resin. Clay is added to the starting mixture involved in production of the activated carbon molded body, as a filler or also as an extrusion additive. However the clay does not sinter together at the pyrolysis temperatures used. As no separate binding agent is added for the clay, that activated carbon molded body does not have a particularly high level of mechanical stability. The relatively low level of mechanical stability therefore means that the activated carbon molded body produced in that fashion is not suitable for durable reliable use in a motor vehicle.

In order to enhance the mechanical stability of the above-discussed molded body, it would be possible to assume that an increase in the proportion of resin, with a corresponding reduction in the proportion of clay, would necessarily result in an improvement in the level of mechanical stability. In manufacturing activated carbon molded bodies, the usual procedure is for the individual components to be mixed together and then extruded. As however activated carbon does not exhibit a plastic behaviour, the activated carbon as such is not extrudable. The clay added as indicated above means that it is possible to extrude the starting mixture. Accordingly, when the proportion of clay in the starting mixture is reduced, that mixture tends to lose its extrusion capability. In that respect it is not possible to increase the amount of resin to the detriment of the amount of clay in order to produce a molded body which is possibly mechanically more stable as such a starting mixture is then no longer extrudable.

The motor vehicle industry however is increasingly demanding filter systems of smaller dimensions, with a higher capacity for pollutants and enhanced stability. Particularly in the case of tank venting systems for motor vehicles, the available structural space is becoming less and less for example in the small two-seater or four-seater ‘city automobiles’ which are being built nowadays. Having regard to the increased ecological requirements, more specifically in regard to the vaporous emission of fuel from motor vehicles, there is a need for the reduced-size filter systems now involved to also have a corresponding adsorption capacity. In addition it is desirable for the service life of the filter systems to be improved by increasing mechanical stability.

Accordingly there is a need for a filter system which enjoys improved stability and an increased adsorption capability.

### SUMMARY OF THE INVENTION

An object of the invention is to provide an activated carbon molded body which enjoys good mechanical stability and which is sufficiently porous to provide for appropriate adsorption effects.

Another object of the present invention is to provide an activated carbon molded body which affords good stability and adsorption capability while being simple to manufacture.

A further object of the invention is to provide a process for the production of a mechanically stable porous activated carbon molded body which while affording satisfactory results is simple and straightforward to implement.

Yet a further object of the present invention is to provide a filter system including a mechanically stable porous activated carbon molded body, such as to enjoy a level of adsorption capability for pollutants as to satisfy the requirements imposed thereon nowadays.

In accordance with the present invention the foregoing and other objects are attained in respect of the molded body by a mechanically stable porous activated carbon molded body comprising a support or lattice structure including carbonised resin and pyrolised silicone resin, and activated carbon particles embedded in said structure.

The above-indicated objects are further attained in accordance with the invention by a filter system including an activated carbon molded body in accordance with the invention.

In the process aspect the foregoing and other objects are attained by a process for the production of a mechanically stable porous activated carbon molded body comprising the steps of mixing activated carbon particles, carbonisable resin, pyrolisable resin and optionally further additives with the addition of a liquid phase to provide a workable mass, shaping the mass obtained to give a molded body, drying the molded body and pyrolysing the dried molded body.

Further preferred features of the invention are set forth in the appendant claims hereinafter.

In relation to the present invention it was surprisingly found that it is possible to obtain an activated carbon molded body which enjoys improved mechanical stability and an enhanced adsorption capability if pyrolisable silicone resin is added to a starting mixture besides activated carbon particles and carbonisable resin. Surprisingly the silicone resin increases the plasticity of the starting mixture so that it can be worked and processed using conventional shaping and molding procedures, in particular extrusion. When using silicone resin in the starting mixture for production of the activated carbon molded body according to the invention, there is no necessity to add clay as is required in DE 101 04 882 A1 as discussed hereinbefore in an increased proportion of up to 50% by weight. An addition of silicone resin has the great advantage of permitting working and processing of the starting mixture by extrusion without clay being added to the mixture.

Accordingly with the activated carbon molded body according to the invention it is possible to increase both the proportion of activated carbon and also the proportion of carbonised resin, wherein workability is possible during production of the activated carbon molded body by means of extrusion by virtue of the addition of the silicone resin.

Use of the silicone resin means that it is also possible to markedly reduce the addition of additives which are necessary in the state of the art such as plasticisers, for example oleic acid, or lubricants, for example glycerin and soap. The reduction in the further additives which are usually necessary such as plasticisers and lubricants further makes it possible to increase the proportions of activated carbon and carbonised phenolic resin in the activated carbon molded body according to the invention.

In accordance with a preferred feature of the invention the silicone resin is in the form of a liquid silicone resin, for example a polysiloxane.

In accordance with a further preferred feature the silicone resin is used in powder form.

It has been found that it may be advantageous to use liquid and powder polysiloxane together in the starting mixture. It has further been found that, when using polysiloxane in powder form, the density of the activated carbon molded body produced in that way can be increased. That makes it possible to further improve the sorption properties of the molded body according to the invention.

In accordance with a preferred embodiment of the invention the silicone resin is a polymer containing a plurality of units in accordance with formula I: 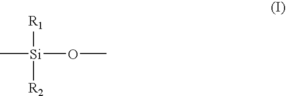
in which R₁ and R₂ may each be the same or different and stand for a substance selected from the group consisting of alkyl, alkenyl and aryl which can each be substituted or unsubstituted or for hydrogen, with the proviso that R₁ and R₂ are not both hydrogen at the same time.

The silicone resin to be used can accordingly also be referred to as polyorganosiloxane.

The terminal groups which are not shown in formula I can be reproduced for example by following formula II:

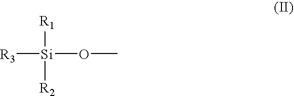

In formula II R₁, R₂ and R₃ may each be the same or different and stand for a substance selected from the group consisting of alkyl, alkenyl and aryl which can each be substituted or unsubstituted or for hydrogen, with the proviso that at least one of R₁, R₂ and R₃ does not stand for hydrogen.

In accordance with a preferred feature the silicone resin is selected from the group consisting of methyl silicone rubber, dimethyl silicone rubber, methyl phenyl silicone rubber, methyl vinyl silicone rubber and mixtures thereof.

Another preferred feature of the invention provides that the silicone resin is present in the pyrolised condition substantially as an SiO₂ lattice or support structure.

Upon carbonisation of the resin used the added silicone resin also undergoes pyrolysis, forming an SiO₂ lattice structure. The SiO₂ structure which is formed during the pyrolysis operation can also contribute to the binding of activated carbon particles. In addition the SiO₂ structure formed advantageously also enhances the mechanical stability of the activated carbon molded body according to the invention.

In accordance with a further preferred feature the resin has aromatic nuclei. In a further preferred feature the resin is selected from the group consisting of phenolic resin, furan resin, epoxy resin, unsaturated polyester resin and mixtures thereof. In a further preferred feature in this respect the phenolic resin is a novolak.

It has been found that, when using resins with aromatic nuclei, in the pyrolysis operation, the procedure gives rise to a porous carbon structure which is particularly suitable for the purposes involved herein. That carbon structure on the one hand reliably fixes the activated carbon particles and, by virtue of the porous structure afforded, permits access for substances which are to be adsorbed, to the activated carbon particles. In addition the carbon structure produced in that way itself appears to afford a certain sorption capability.

It has been found that the molded body according to the invention enjoys excellent embedding or fixing of activated carbon particles in the three-dimensional lattice structure produced by carbonisation of preferably synthetic resin.

In a further preferred feature the activated carbon particles are substantially completely bound by the carbonised resin.

In a further preferred feature the activated carbon molded body according to the invention contains less than about 20% by weight of calcined and/or refractory material, preferably less than about 15% of calcined ceramic and/or refractory material, in each case with respect to the total weight of the activated carbon molded body. In a further preferred feature the activated carbon molded body contains less than about 10% of calcined ceramic and/or refractory material with respect to the total weight of the molded body.

The small proportion of calcined ceramic and/or refractory material in the starting mixture for production of the molded body means that it is: possible to increase the proportion of resin to be carbonised and activated carbon particles in order to provide an activated carbon molded body which enjoys enhanced mechanical stability and improved adsorption capability.

In a further preferred embodiment of the invention the activated carbon molded body contains between about 15% by weight and about 60% by weight, preferably between about 20% by weight and 50% by weight of carbonised resin, with respect to the total weight of the molded body. It is further preferred for the activated carbon molded body to contain between about 0.50/c by weight and about 25% by weight and preferably between about 2% by weight and about 20% by weight of pyrolised silicone resin.

It will be noted at this juncture that the proportions specified in percent by weight hereinbefore and hereinafter relate in each case to the total weight of the activated carbon molded body unless otherwise stated.

In accordance with a further embodiment of the invention the activated carbon molded body contains between about 15% by weight and about 60% by weight, preferably between about 30% by weight and about 50% by weight of activated carbon.

The lattice structure which is produced from carbonisation of resin, preferably synthetic resin, preferably binds the activated carbon or activated carbon particles. The activated carbon or the particles thereof are partially embedded in or fixed to the porous carbon structure produced upon carbonisation of the resin so that the result is an abrasion-resistant, mechanically stable structure enjoying a very good level of sorption capability. A porous carbon which is produced by the carbonisation of resin is referred to as glass-like carbon.

The SiO₂ lattice structure produced by the pyrolysis of silicone resin can also lead to binding, fixing or embedding of the activated carbon particles. In addition, the SiO₂ lattice structure produced also provides for stabilisation of the activated carbon molded body produced.

Preferably no clay is added in production of the molded body according to the invention. It has been found that, when using calcined ceramic and/or refractory material, instead of the clay which is usually employed in prior procedures, production of the activated carbon molded body according to the invention affords a reduction in the water content in the entire batch and thus a reduction in the degree of drying shrinkage. Preferably fire clay is used as the ceramic material and/or calcined refractory material.

A further preferred embodiment of the invention provides that the activated carbon molded body contains stabilisation fibers. For example glass fibers and/or carbon fibers can be used for that purpose. It is noted that the addition of stabilisation fibers advantageously improves mechanical stability of the porous molded body of the invention.

It has been found that a passage structure affords a sufficiently large area for substances to be adsorbed, usually pollutants. That structure at the same time affords satisfactory mechanical stability.

In accordance with a preferred feature of the activated carbon molded body it has a passage structure. That structure may have passages which extend through the body and/or passages which do not extend entirely therethrough. The passages may extend in a straight line and/or in a configuration differing from a straight line, for example in a wavy or corrugated configuration. The activated carbon molded body is accordingly preferably in the form of a molded body with passages extending therethrough, the passages preferably being straight.

The passages may be of any desired geometrically regular and/or irregular, that is to say general shape. A geometrically regular shape has proven to be an advantageous shape for a passage cross-section, in particular a tetragonal, preferably square, hexagonal, octagonal and/or circular shape.

The term shape of a passage cross-section is used to denote the shape of the cross-section of an individual passage, the cross-section being perpendicular to the axis of the passage. In the case of passages which are not straight the axis of the passage is similarly not straight. The shape of the passage cross-section of the individual passages is simply referred to hereinafter as the passage shape.

It was found that the passage shape has an influence on the flow resistance of the activated carbon molded body. It was found in this respect that, in the case of a gas which is passed through the activated carbon molded body, in dependence on the passage shape, regions are formed involving differing flow speeds.

This signifies that a flow resistance is set in dependence on the passage shape. That flow resistance can be measured by recording the pressure of the gas before it flows into the activated carbon molded body and after it flows out of the body. The pressure drop in the flow is then a measurement in respect of the flow resistance in the activated carbon molded body.

The internal wall surfaces of the individual passages act as frictional surfaces and are responsible to a considerable extent for the pressure drop. It has been found that, with the same sum of the surface areas of the passage cross-sections, the pressure drop is dependent on the passage shape.

The area of the cross-section of an passage is referred to hereinafter as the passage cross-sectional area. The sum of the passage cross-sectional areas is referred to hereinafter as the open area.

In addition the term frictional surface is used to denote the internal wall surface of the passage. When a passage is of a circular passage shape, the frictional surface is of smaller area than for all other passage shapes of the same passage cross-sectional area.

When a gas flows through an activated carbon molded body of a square passage shape, lower flow speeds occur in the corner regions, in comparison with flow speeds in the proximity of the passage axis. The greater the passage shape approaches a circular passage shape, the correspondingly smaller become the regions which involve low flow speeds. A regularly hexagonal passage shape comes close to a circular passage shape, in which respect, with the regularly hexagonal passage shape, it is also possible to optimise the open area and accordingly it is possible to achieve a large open area.

In comparative measurement procedures, it was found that an activated carbon molded body which involves a regularly hexagonal passage shape exhibits a lower flow resistance compared to an activated carbon molded body involving a square or tetragonal passage shape of the same passage cross-sectional area.

Accordingly the pressure drop in an activated carbon molded body which has passages of a hexagonal passage shape is less than in an activated carbon molded body having passages of a tetragonal passage shape.

In a preferred embodiment therefore the activated carbon molded body has a regularly hexagonal passage shape, that is to say a honeycomb structure.

In accordance with another preferred feature of the invention the activated carbon molded body has passages of a tetragonal passage cross-section as such an activated carbon molded body can be produced on conventional extruders.

It has been found that the activated carbon molded body of the invention can enjoy an extremely high level of mechanical stability, as indicated by the fact that in a preferred configuration wherein the activated carbon molded body is of a cylindrical shape with a diameter of substantially 30 mm, a length of substantially 100 mm and a cell provision of 200 cells per square inch (cpsi), that is to say 200 passages of approximately square or regular hexagonal cross-section, with the passages extending through the body, the molded body has a bursting force in parallel relationship with the direction in which the passages extend of at least 2000 N, preferably at least 2500 N. It is further preferred for the bursting force to be at least 3000 N, further preferably at least 3500 N or more preferably at least 4000 N.

An activated carbon molded body according to the invention of the above-specified dimensions also has an improved bursting force in perpendicular relationship to the direction in which the passages extend, the bursting force advantageously being at least 200 N and further preferably at least 400 N.

In the process for producing the mechanically stable porous activated carbon molded body according to the invention, which involves mixing the components as specified above, shaping them to provide a molded body, drying the molded body and pyrolysing the dried molded body, the liquid phase added in the mixing step is preferably an aqueous phase or water. The viscosity of the mixture can be adjusted by way of the amount of water added. The plasticity of the mixture or starting composition can further be adjusted by way of the added silicone resin, preferably polysiloxane.

Although the added silicone resin, preferably polyorganosiloxane imparts adequate plasticity or extrusion capability to the starting mixture, it will be appreciated that it is also possible to add further additives. For example it is possible to add wax to the mixture in order to provide for good slidability of the individual particles relative to each other, that is to say thereby to improve the factor of what is known as internal slidability. Improved internal slidability promotes homogeneous distribution of the individual constituents during extrusion of the material at the aperture of the extruder. In addition increasing internal slidability can have the extremely advantageous effect of at least substantially avoiding local accumulation or blockage effects in individual passages of the extruder aperture in the extrusion operation.

A tenside or soap can also be added to the starting material in the mixing step in order to improve sliding of the material in the extruder or at the extrusion tool. A comparable effect can be achieved if between about 10 and 50% by weight of the tenside or soap proportion is replaced by graphite powder.

The good plasticising effect of the silicone resin added means that the proportion of further additives can surprisingly be reduced. In that respect the mixture can contain on a percentage basis more activated carbon and carbonisable resin than was previously possible.

For the purposes of improving the strength of the article obtained after the extrusion operation, generally referred to as the green body, a preferred feature provides that a binding agent is added, for example liquid starch, cellulose ether or a cellulose derivative, for example methyl hydroxypropyl cellulose.

The cellulose ether referred to above binds the water added in the mixing step of the production process, outside the activated carbon, and thus contributes to stabillsatlon of the green body produced. In addition the green body binding agent also promotes homogenisation of the starting mixture comprising activated carbon, the optionally added ceramic or refractory material, silicone resin and the preferably synthetic carbonisable resin. In the starting mixture, the cellulose ether opposes separation thereof which is to be attributed to the differing densities of the various constituents.

By way of example the cellulose ether used may include methyl cellulose, ethylhydroxyethyl cellulose, hydroxybutyl cellulose, hydroxybutylmethyl cellulose, hydroxyethyl cellulose, hydroxymethyl cellulose, hydroxypropyl cellulose, methylhydroxypropyl cellulose, hydroxyethylmethyl cellulose, sodium carboxymethyl cellulose and mixtures thereof.

Preferably the amount of added green body binding agent, for example cellulose ether, is not more than about 5% by weight with respect to the total weight of the starting mixture. Otherwise there is the risk that, upon pyrolysis of the extruded activated carbon molded body, excessively large defects occur in the form of macroporosity, due to the green body binding agent being burnt out.

Preferably, when adding water for adjusting the viscosity of the material prepared in the mixing step, up to 20% by weight of the water can be added mixed with a portion of the cellulose ether. That can advantageously avoid excessive adsorption of the water in or on the activated carbon.

After the shaping or molding operation, preferably by extrusion, of the material obtained in the mixing step to provide a shaped or molded body, the body is preferably cut to the desired length and preferably subsequently dried. Drying is preferably subsequently effected using microwave heating or by a combination of microwave irradiation with conventional circulatory air drying at temperatures of between about 50° C. and about 80° C. It will be appreciated that it is also possible to use other drying procedures.

It has been found that it is advantageous if the moisture is removed permanently and quickly in order to avoid splitting of the extruded molded body during the drying operation. Preferably the molded body is dried until the water content is about 2.5/% by weight or less.

In the pyrollsing step of the production process the molded body produced in the drying step is firstly heated preferably to a temperature which is above the melting temperature of the preferably synthetic resin, to provide a pre-hardened green body. In that heating step the preferably synthetic resin which added in the mixing step melts and embeds the activated carbon particles into the resulting molten material.

In a preferred embodiment the pyrolysis operation is carried out in an inert gas atmosphere, the inert gas used preferably being nitrogen.

The resins used are preferably the above-mentioned resins with aromatic nuclei as well as synthetic resins. Phenolic resins, furan resins, epoxy resins, unsaturated polyester resins and mixtures thereof have proven to be highly suitable. Preferably novolak resins are employed.

A preferred embodiment of the production process provides that the resin is added in the mixing step in powder form. That has the extremely advantageous effect that the pores of the activated carbon particles are not closed or blocked by the resin as long as the resin has not melted. In order to implement adequate embedding of the activated carbon particles and thus fixing thereof in the carbon lattice structure produced in carbonisation of the preferably synthetic resin, the amount of resin should be selected to be sufficiently large, in relation to the amount of activated carbon used.

During the pyrolysis step the temperature is increased until carbonisation of the resin material employed takes place. During carbonisation of the resin material a porous solid carbon structure is formed, referred to as glass-like carbon. The activated carbon particles are then preferably fixed in that porous carbon structure. The pores of the activated carbon, which are possibly occupied with resin material, are accessible again for adsorption purposes due to the carbonisation procedure and the formation of a porous carbon structure.

Pyrolysis or carbonisation of the carbonisable resin is preferably implemented at a final temperature which is in a range of between about 350° C. and about 550° C., preferably at about 450° C. That temperature is preferably maintained for a period of between about 60 minutes and about 80 minutes.

The end of pyrolysis of the resin material can be controlled by monitoring the pyrolysis products which fume off. As soon as substantially no new decomposition products are produced, pyrolysis or carbonisation is terminated.

During the pyrolysis operation the additives which are optionally added such as for example wax, tenside or soap, cellulose ether or starch are also carbonised or decomposed.

A final temperature of 750° C. has proven to be particularly advantageous for forming the SiO₂ structure from the silicone resin during the pyrolysis operation as that temperature makes it possible to achieve the highest levels of mechanical strength in the finished molded body.

It has been found that the sorption characteristics of the activated carbon molded body which can be produced by the process according to the invention can also be influenced by way of the properties of the activated carbon. Essential parameters in that respect include pore size, pore size distribution and the active surface area of the activated carbon used, as well as the particle size and particle size distribution of the activated carbon. All types of activated carbon can be used with this invention. Thus, both a microporous coconut carbon with more than 95% micropore proportion and a BET surface area of 1200 m²/g was used, and also a mesoporous charcoal with a mesopore proportion of more than 50% and a BET surface area of 2000 m²/g.

The former is preferably employed in cabin air filtration for odor elimination and the latter is preferably used in tank venting and solvent recovery. What is essential is that in both cases the pore structure is also retained in the finished molded body.

Preferably the synthetic resin material used is a novolak material in powder form, which is a partially cross-linked phenolformaidehyde resin and has a melting point of between 80° C. and 160° C., in particular between about 100° C. and 140° C.

The proportion of stabilisation fibers which are optionally added can be selected in dependence on the other components. In that respect the melting point of the added fibers should be above the maximum set pyrolysis temperature so that they do not melt during the pyrolysis procedure. If glass powder or glass frit material is additionally added to the mixture in the mixing step of the production process, additional cross-linking takes place between the glass fibers in the final product. Preferably, for mechanical stabilisation of the final product, about 10% by weight with respect to the weight of the activated carbon, glass fibers and glass frit material is added to the mixture produced in the mixing step of the process.

The present invention will be described in greater detail hereinafter by means of Examples and with reference to the accompanying Figures of drawings. It will be appreciated that the Examples and the drawings are provided exclusively for further explanation of the invention and are not deemed to constitute a limitation in respect thereof.

### BRIEF DESCRIPTION OF THE DRAWINGS

FIG. 1 shows a diagram indicating the proportions by weight of activated carbon, carbonised resin, calcined ceramic and SiO₂ (pyrolysed silicone resin) of two embodiments of the invention as indicated at AFB 1 and AFB 2 in comparison with the state of the art disclosed in DE 101 04 882 A1,

FIG. 2 shows the bursting force parallel to the direction in which the passages extend and in perpendicular relationship to that direction of embodiment 1 as indicated at AFB 1 and embodiment 2 as indicated at AFB 2 in comparison with the state of the art disclosed in DE 101 04 882 A1,

FIG. 3 shows the working capacity and residual loading respectively in g of the activated carbon filters of embodiment 1 as indicated at AFB 1 and embodiment 2 as indicated at AFB 2 and a filter which was produced in accordance with the comparative composition set forth in Table 1 hereinafter, based on the system disclosed in DE 101 04 882 A1, and having the same cell density and external dimensions as the filters of AFB 1 and AFB 2,

FIG. 4 shows the n-butane break-through curves for a foam system and a 400 cell arrangement according to the invention, in each case for a filter depth of 40 mm,

FIG. 5 shows a passage cross-section of a square passage shape in accordance with a Computatonal Fluid Dynamics (CFD) simulation calculation,

FIG. 6 shows a passage cross-section of a regularly hexagonal passage shape in accordance with a CFD simulation calculation, and

FIG. 7 shows a graph in respect of an experimental pressure drop measurement procedure.

### DESCRIPTION OF PREFERRED EMBODIMENTS

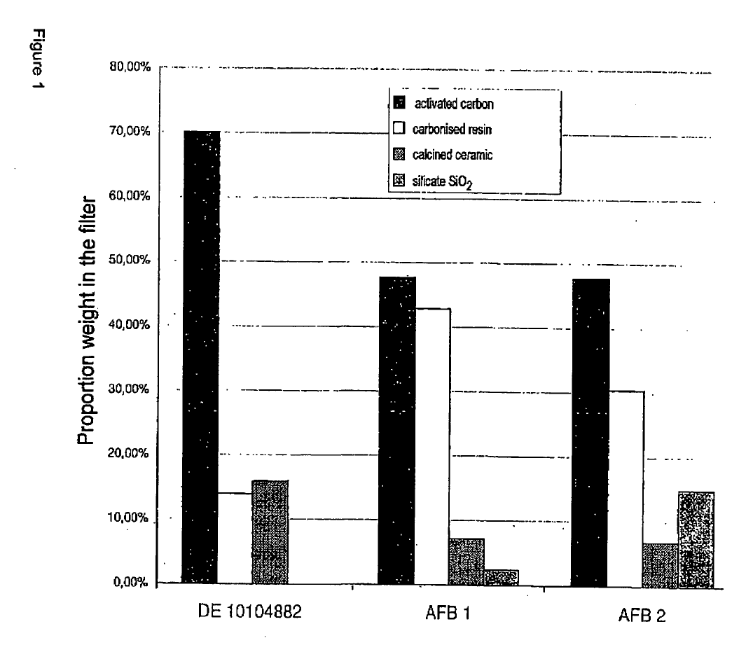

Reference is made to FIG. 1 showing the relative proportions of activated carbon, carbonised resin, calcined ceramic and the silicate SiO₂ produced from pyrolysed silicone resin of embodiment 1 as indicated at AFB 1 and embodiment 2 as indicated at AFB 2 in comparison with a conventional activated carbon filter in accordance with the teaching of DE 101 04 882 A1. It can be clearly seen from FIG. 1 that the proportion of activated carbon in the case of the activated carbon filter of DE 101 04 882 A1 is greater and the proportion of carbonised resin is markedly less, in comparison with the corresponding proportions of those constituents in the activated carbon filters of embodiments 1 and 2 of the invention. Unlike the filter in accordance with DE 101 04 882 A1 the two activated carbon molded bodies according to the invention additionally include a proportion of SiO₂ produced from pyrolysed silicone resin.

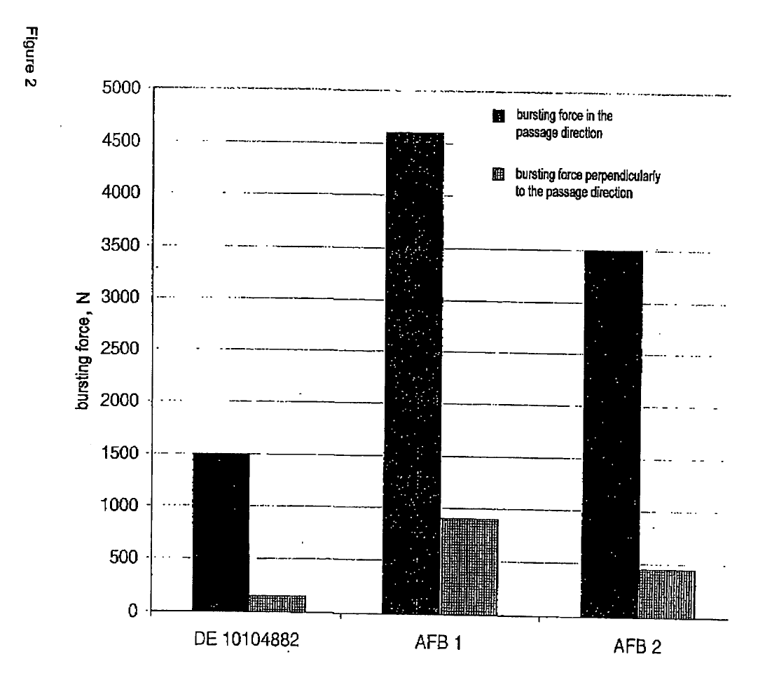

Attention is now drawn to FIG. 2 showing the bursting force in Newtons [N] for the activated carbon molded bodies shown in FIG. 1. It can be clearly seen that the molded body disclosed in DE 101 04 882 A1 involves a substantially lower level of bursting force both in a direction parallel to and also perpendicularly to the orientation of the passages. FIG. 2 clearly shows that the bursting force of the activated carbon molded bodies of embodiment 1 and embodiment 2 respectively is a multiple greater than in the case of the activated carbon molded body disclosed in DE 101 04 882 A1.

The bursting force was measured on activated carbon molded bodies of a diameter of 30 mm, a length of 100 mm and a cell configuration of 200 cpsi (cells per square inch). In that respect the bursting force is denoted by the applied force at which the activated carbon molded body ruptured. The force is specified in Newtons. The bursting force was determined by means of a material tensile testing machine from Zwick, 89079 Ulm, Federal Republic of Germany, with a maximum advance movement of 25 mm/minute, with a foam rubber member of a thickness of 5 mm being disposed between the pressure plates of the machine and the test body in order to homogenise the pressure forces applied.

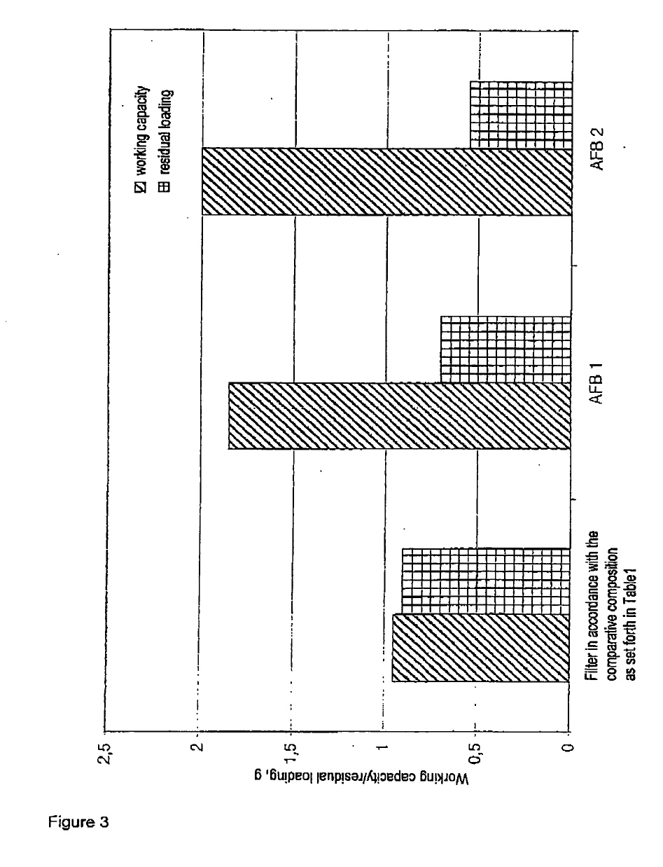

FIG. 3 shows the working capacity and the residual loading with n-butane in the case of the activated carbon molded bodies according to the invention of embodiment 1 and embodiment 2 and a filter which was produced in accordance with the comparative composition set forth in Table, 1 hereinafter based on DE 101 04 882 A1 and which has the same cell density and outside dimensions as the filters of embodiments 1 and 2.

By virtue of the markedly higher proportion of resin the comparative filter enjoys a higher level of mechanical stability than the filter from the state of the art disclosed in DE 101 04 882 A1. It will be noted however that this is to the detriment of the adsorption efficiency at high levels of hydrocarbon concentration. Likewise a filter which was produced in accordance with that comparative composition has a very high residual loading. FIG. 3 makes it clear that the filters of embodiment 1 and embodiment 2 have a markedly higher working capacity with a reduced residual loading in comparison with the comparative example.

The FIG. 3 diagram also makes it clear that the use of a silicone resin in powder form as an additional component makes it possible to increase the working capacity and reduce the residual loading. A residual loading which is as low as possible, with a high working capacity, is of great significance in particular in terms of use as a residual emissions filter in the sector of automobile fuel tank venting.

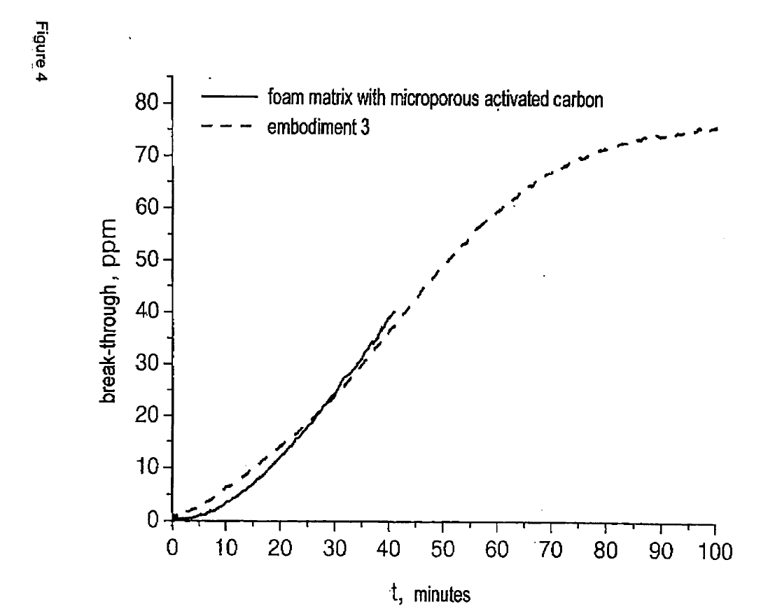

Reference is now made to FIG. 4 showing the n-butane break-through curves of a foam system and a 400 cell system according to the invention, in each case for a filter depth of 40 mm.

It can be clearly seen that the passage structure of the 400 cell system has the same adsorption dynamics as the foam system with microporous activated carbon which is used as the comparison. As the structure however has only a third of the air resistance (this aspect is not shown) in comparison with the foam system, the molded body system according to the invention affords a considerable technical advantage over a foam impregnated with microporous activated carbon.

The foam system comprises four layers of a 10 mm thick cross-linked PU foam which was impregnated with activated carbon granules. That material can be obtained from helsa-automotive GmbH, 95479 Gefrees, Federal Republic of Germany, under the material designation 8126.

The activated carbon filters compared in FIGS. 1 and 2 in accordance with DE 101 04 882 A1 and embodiment 1 indicated at AFB 1 and embodiment 2 indicated at AFB 2 are of the respective compositions set forth in Table 1 hereinafter.

TABLE 1

| | DE 101 04 | Comparative | | |
|---|---|---|---|---|
| Component | 882 A1 | composition (FIG. 3) | AFB 1 | AFB 2 |
| Activated | 35.3% | 12.7% | 20.0% | 21.0% |
| carbon | | | | |
| Resin | 11.7% | 35.0% | 30.0% | 22.3% |
| Clay | 8.0% | 8.0% | — | — |
| Calcined | — | — | 3.0% | 3.0% |
| ceramic | | | | |
| Water | 28.7% | 28% | 37.5% | 37.5% |
| Polysiloxane, | — | — | 1.7% | 2.5% |
| liquid | | | | |
| Polysiloxane, | — | — | — | 5.90% |
| powder | | | | |
| Green binder | 9.5% | 9.5% | 4.0% | 4.0% |
| Lubricant | 4.5% | 4.5% | 1.0% | 1.0% |
| additive | | | | |
| plasticiser | 0.7% | 0.7% | 1.8% | 1.8% |
| Soap | 1.6% | 1.6% | 1.0% | 1.0% |

Embodiment 1

150 g of a fire clay was added to a mixture of 1500 g of a phenolic resin in powder form with 10009 of activated carbon powder. 200 g of a cellulose ether was added to the mixture as a green binder. Finally 1875 g of water was added to the material and the substances were mixed and kneaded in a kneader to form a homogeneous mass. 50 g of a polyglycol, 50 g of soap and 90 g of oleic acid were added as extrusion additives. 85 g of liquid methylphenylvinyl hydrogen polysiloxane was added to the mass as the silicone resin component.

That mass was extruded in a 200 cell system, dried by means of microwaves and pyrolysed in a pyrolysis furnace in a nitrogen atmosphere at 750° C.

An operation of determining working capacity was carried out on that filter, based on ASTM D 5228-92. The set n-butane concentration was 50% in air, and the volume through-put for loading was 0.1 l/min and for desorption 22 I/min. The system was loaded up to a break-through of 5000 ppm and then desorbed with the 22 l/min of air for 15 minutes. The result was a working capacity of 1.85 g. The residual loading on the filter was 0.7 g.

Embodiment 2

The mode of operation involved in production of the body is the same as in embodiment 1. The individual components are made up as follows: activated carbon 10509; phenolic resin 1115 g; fire clay 150 g; cellulose ether 200 g; water 18759; polyglycol 50 g; soap 50 g; oleic acid 90 g; and liquid silicone resin 125 g. Here 295 g of a phenylmethyl, polysiloxane was added as a new and additional component. The other component correspond to those specified in embodiment 1.

The same operation of determining working capacity was carried out on this filter as in embodiment 1. The result obtained was a working capacity of 29 and a residual loading of 0.55 g. The difference in terms of composition in relation to the state of the art is clearly indicated by Table 1. It will be seen that the amount of extrusion additives could be markedly reduced. The differing composition in the finished filter is illustrated by FIG. 1. A marked difference in comparison with the state of the art is in respect of the ratio of activated carbon to carbonised resin.

The third embodiment described hereinafter now shows that a molded body which was produced in accordance with the novel composition of the invention can also be very satisfactorily used for gas cleaning purposes at low levels of concentration.

Embodiment 3

The composition involved is the same as in embodiment 1. In this case however a molded body with a cell configuration of 400 cpsi, a diameter of 25 mm and a length of 40 mm was produced. That filter was measured with the same afflux speed of 0.6 m/s as is usual in testing foam matrix systems for odor filters for cabin air filtration in a motor vehicle Measurement was implement with n-butane at a concentration of 80 ppm. The temperature was 23° C. and the relative humidity was 20%. FIG. 4 shows the break-through curves for a foam system and for the 400 cell system, in each case for a filter depth of 40 mm. It can be clearly seen that the passage structure involves the same adsorption dynamics as the foam system. As however the structure has only one third of the air resistance of the foam system, it enjoys a considerable technical advantage from the point of view of a potential user.

Embodiment 4

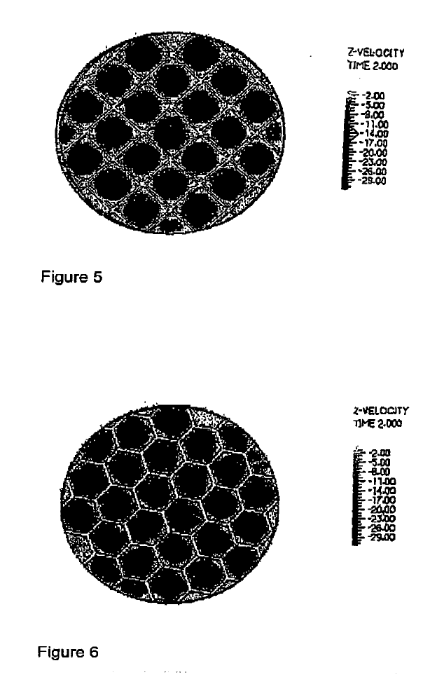

Embodiments 1 through 3 show activated carbon molded bodies involving a regularly tetragonal passage shape. The present Example demonstrates the advantages of an activated carbon molded body with a regularly hexagonal passage shape in comparison with an activated carbon molded body with a square passage shape. FIGS. 5 and 6 correspondingly show the regularly hexagonal shape and the square shape.

For illustrative purposes, the passage shapes shown in FIGS. 5 and 6 were used to implement Computational Fluid Dynamics (CFD) simulation calculations with the ADINA-F8.0 program (see www.adina.com). The dimensions of the theoretical activated carbon molded body on which the calculation was based involve as fixed parameters an open area of 78% of the cross-sectional area of the total molded body and a spacing in respect of the passage walls which are in mutually opposite relationship in an individual passage of 6.52 mm. Therefore, the wall thickness as a variable parameter was 0.7 mm for the regularly hexagonal passage shape and 0.75 mm for the square passage shape. The gray scales shown in FIGS. 5 and 6 illustrate the flow speeds within the passages. The gray scales can also be seen from the respectively accompanying indicator scale.

It will be clear from a comparison of FIGS. 5 and 6 that the square, passage shape involves markedly stronger flows in the proximity of the passage axis and the cross-sectional area of an individual passage is used less greatly than with the regularly hexagonal passage shape. The consequence is a greater pressure drop with the square passage shape in comparison with the regularly hexagonal one. By calculation, that gives a 20% lower pressure drop from the CFD simulation calculations, with the hexagonal passage shape.

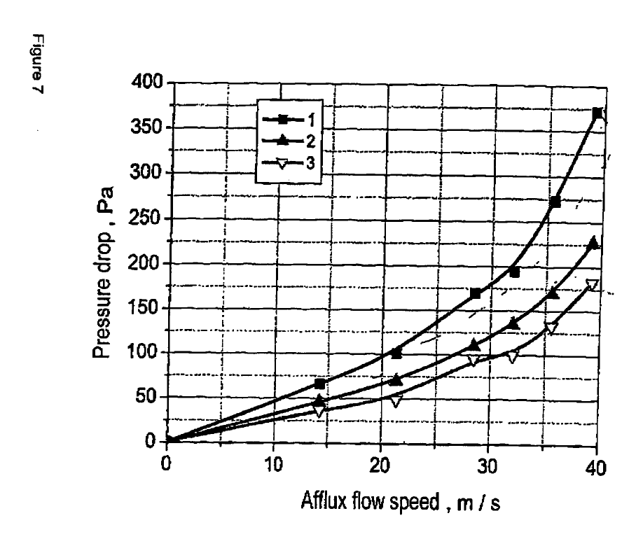

The theoretical results were checked on the basis of experimental measurement procedures. Three activated carbon molded bodies were measured, which each had an open area of 78% of the cross-sectional area of the overall activated carbon molded body:
(1) an activated carbon molded body with a regularly hexagonal passage shape and the same dimensions as were the basis for the theoretical calculation (line 3 in FIG. 7),
(2) an activated carbon molded body with a square passage shape and the same dimensions as were the basis for the theoretical calculation (line 2 in FIG. 7), and
(3) an activated carbon molded body with a square passage shape in, which the spacing of the passage walls in mutually opposite relationship in an individual passage was 4.8 mm and the wall thickness was 0.55 mm, (line 1 in FIG. 7). The inner edges of the passages were additionally supported by round reinforcement portions of a diameter of 2 mm. By virtue of the markedly thinner wall thicknesses, this molded body also involved an open area of 78% of the cross-section of the whole activated carbon molded body and thus had a larger number of passages and accordingly a larger frictional surface area than activated carbon molded bodies (1) and (2).

Reference is now made to FIG. 7 showing a graph plotting the pressure drop in Pa in dependence on the amux flow speed in m/s for the three activated carbon molded bodies described hereinbefore. The relationship between passage shape and/or frictional area can be derived from FIG. 7. The increase in pressure drop is due both to the passage shape and also the frictional area. It can be estimated from FIG. 7 that the passage shape contributes 25% and the frictional area 75% to the increase in the pressure drop.

The invention as described hereinbefore has been set forth solely by way of example and Illustration thereof and it will be appreciated that other modifications and alterations may be made therein without thereby departing from the spirit and scope of the invention.

1. A mechanically stable porous activated carbon molded body comprising
a lattice structure including carbonised resin and pyrolysed silicone resin, and
activated carbon particles embedded in said structure.

2. An activated carbon molded body as set forth in claim 1
wherein the silicone resin is a polymer containing a plurality of units in accordance with formula I: 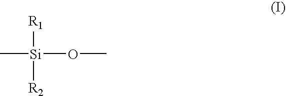
in which r₁ and r₂ may each be the same or different and stand for a substance selected from the group consisting of alkyl, alkenyl and aryl which can each be substituted or unsubstituted or for hydrogen, with the proviso that r₁ and r₂ are not both hydrogen at the same time.

3. An activated carbon molded body as set forth in claim 1
wherein the silicone resin is selected from the group consisting of methyl silicone rubber, methyl phenyl silicone rubber, methyl vinyl silicone rubber and mixtures thereof.

4. An activated carbon molded body as set forth in claim 1
wherein the silicone resin is present in the pyrolysed condition substantially as an SiO₂ lattice structure.

5. An activated carbon molded body as set forth in claim 1
wherein the carbonisable resin has aromatic nuclei.

6. An activated carbon molded body as set forth in claim 1
wherein the resin is selected from the group consisting of phenolic resin, furan resin, epoxy resin, unsaturated polyester resin and mixtures thereof.

7. An activated carbon molded body as set forth in claim 1
wherein the phenolic resin is a novolak.

8. An activated carbon molded body as set forth in claim 1 containing
less than about 20% by weight and preferably less than about 15% by weight of at least one of calcined ceramic and refractory material with respect to the total weight of the activated carbon molded body.

9. An activated carbon molded body as set forth in claim 8 containing
less than about 10% by weight of at least one of calcined ceramic and refractory material with respect to the total weight of the activated carbon molded body.

10. An activated carbon molded body as set forth in claim 1 containing
between about 15% by weight and about 60% by weight and preferably between about 20% by weight and about 50% by weight of carbonised resin with respect to the total weight of the activated carbon molded body.

11. An activated carbon molded body as set forth in claim 1 containing
between about 0.5% by weight and about 25% by weight and preferably between about 2% by weight and about 20% by weight of pyrolysed silicone resin with respect to the total weight of the activated carbon molded body.

12. An activated carbon molded body as set forth in claim 1 containing
between about 15% by weight and about 60% by weight and preferably between about 30% by weight and about 50% by weight of activated carbon with respect to the total weight of the activated carbon molded body.

13. An activated carbon molded body as set forth in claim 1 including stabilisation fibers.

14. An activated carbon molded body as set forth in claim 16
wherein said stabilisation fibers include at least one of glass fibers and carbon fibers.

15. An activated carbon molded body as set forth in claim 1 with
a passage structure with passages preferably extending therethrough.

16. An activated carbon molded body as set forth in claim 15
wherein the activated carbon molded body is of a cylindrical shape with a diameter of substantially 30 mm, a length of substantially 100 mm and a cell provision of 200 passages per square inch,
wherein the passages extend through the activated carbon molded body in parallel relationship with the longitudinal axis thereof, and
wherein the activated carbon molded body has a bursting force in parallel relationship with the direction in which the passages extend of at least 2000 N, preferably at least 2500 N.

17. An activated carbon molded body as set forth in claim 16
wherein said bursting force is at least 3000 N.

18. An activated carbon molded body as set forth in claim 16
wherein said bursting force is at least 3500 N.

19. An activated carbon molded body as set forth in claim 15
wherein the activated carbon molded body is of a cylindrical shape with a diameter of substantially 30 mm, a length of substantially 100 mm and a cell provision of 200 passages per square inch,
wherein the passages extend through the activated carbon molded body in parallel relationship with the longitudinal axis thereof, and
wherein the activated carbon molded body has a bursting force in perpendicular relationship to the direction in which the passages extend of at least 200 N, preferably at least 400 N.

20. An activated carbon molded body as set forth in claim 15
wherein the passages are of a tetragonal cross-section.

21. An activated carbon molded body as set forth in claim 15
wherein the passages are of a hexagonal cross-section.

22. An activated carbon molded body as set forth in claim 15
wherein the activated carbon particles are substantially fixed to the carbonised resin.

23. A filter system including an activated carbon molded body, wherein the body comprises
a lattice structure including carbonised resin and pyrolysed silicone resin, and
activated carbon particles embedded in said structure.

24. A process for the production of a mechanically stable porous activated carbon molded body including the steps of
mixing activated carbon particles, carbonisable resin, pyrolysable silicone resin and optionally further additives with the addition of a liquid phase to provide a workable mass,
shaping the mass obtained to give a molded body,
drying the molded body, and
pyrolising the dried molded body.

25. A process as set forth in claim 24
wherein the liquid phase is aqueous.

26. A process as set forth in claim 25
wherein the liquid phase is water.

27. A process as set forth in claim 24
wherein the silicone resin is a polymer containing a plurality of units in accordance with formula I: 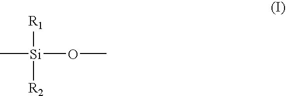
in which R₁ and R₂ may each be the same or different and stand for a substance selected from the group consisting of alkyl, alkenyl and aryl which can each be substituted or unsubstituted or for hydrogen, with the proviso that R₁ and R₂ are not both hydrogen at the same time.

28. A process as set forth in claim 24
wherein the silicone resin is selected from the group consisting of methyl silicone rubber, methyl phenyl silicone rubber, methyl vinyl silicone rubber and mixtures thereof.

29. A process as set forth in claim 24
wherein the pyrollsable silicone resin is converted during the pyrolysis step substantially to an SiO₂ lattice structure.

30. A process as set forth in claim 24
wherein the carbonisable resin has aromatic nuclei.

31. A process as set forth in claim 24
wherein the resin is selected from the group consisting of phenolic resin, furan resin, epoxy resin, unsaturated polyester resin and mixtures thereof.

32. A process as set forth in claim 31
wherein the phenolic resin is a novolak.

33. A process as set forth in claim 22
wherein in the mixing step at least one material selected from the group consisting of ceramic material and refractory material is added in such an amount that the activated carbon molded body after the pyrolysis step contains less than about 20% by weight of said calcined added material with respect to the total weight of the activated carbon molded body.

34. A process as set forth in claim 33
wherein in the mixing step at least one material selected from the group consisting of ceramic material and refractory material is added in such an amount that the activated carbon molded body after the pyrolysis step contains less than about 15% of said calcined added material with respect to the total weight of the activated carbon molded body.

35. A process as set forth in claim 33
wherein in the mixing step at least one material selected from the group consisting of ceramic and refractory material is additionally added in an amount such that after the pyrolysis step the activated carbon molded body contains less than about 10% of said calcined added material with respect to the total weight of the activated carbon molded body.

36. A process as set forth in claim 24
wherein in the mixing step carbonisable resin is added in an amount such that after the pyrolysis step the activated carbon molded body contains between about 15% by weight and about 60% by weight of carbonised resin with respect to the total weight of the activated carbon molded body.

37. A process as set forth in claim 36
wherein after the pyrolysis step the activated carbon molded body contains between about 20% by weight and about 50% by weight of carbonised resin with respect to the total weight of the activated carbon molded body.

38. A process as set forth in claim 24
wherein in the mixing step pyrolysable silicone resin is added in an amount such that after the pyrolysis step the activated carbon molded body contains between about 0.5% by weight and about 250/% by weight of pyrolised silicone resin with respect to the total weight of the activated carbon molded body.

39. A process as set forth in claim 38
wherein after the pyrolysis step the activated carbon molded body contains between about 2% by weight and about 20% by weight of pyrolised silicone resin with respect to the total weight of the activated carbon molded body.

40. A process as set forth in claim 24
wherein in the mixing step activated carbon is added in an amount such that after the pyrolysis step the activated carbon molded body contains between about 15% by weight and about 60% by weight with respect to the total weight of the activated carbon molded body.

41. A process as set forth in claim 40
wherein after the pyrolysis step the activated carbon molded body contains between about 30% by weight and about 50% by weight with respect to the total weight of the activated carbon molded body.

42. A process as set forth in claim 24
wherein stabilising fibers are additionally added in the mixing step.

43. A process as set forth in claim 42
wherein said stabilising fibers are selected from the group consisting of glass fibers and carbon fibers.

44. A process as set forth in claim 24
wherein the molding operation is effected by means of extrusion and additives optionally added in the mixing step include extrusion additives such as a substance selected from wax, fatty acids, soap, plasticiser and green body binding agent.

45. A process as set forth in claim 44
wherein the green body binding agent is selected from the group consisting of liquid starch, cellulose ether and a cellulose derivative.

46. A process as set forth in claim 45
wherein said green body binding agent is methylhydroxypropyl cellulose.

47. A process as set forth in claim 24
wherein in the drying step drying is effected in a circulatory air furnace or by irradiation with microwaves or by a combination of microwave irradiation with hot air.
